(19) United States
(12) Patent Application Publication
(10) Pub. No.: US 2003/0078332 A1
(43) Pub. Date: Apr. 24, 2003

(54) Conductive polymer-particle blends

(76) Inventor: Peter S. Dardi, Saint Paul, MN (US)

Correspondence Address: Peter S. Dardi, 574 Mount Curve Blvd., Saint Paul, MN, 55116, US

(21) Appl. No.: 10/012,448

(22) Filed: Oct. 19, 2001

(51) Int. Cl. C08K 3/18; C08K 3/08

(52) U.S. Cl. 524/439; 524/430

(57) ABSTRACT

Blends are described involving electrically conductive polymer and solid particles, in which the electrically conductive polymer binds the particles to form a cohesive material. In embodiments of particular interest, the blends include at least about 10 weight percent solid particles. The electrically conductive polymers have sufficient cohesiveness to function as a binder. In some embodiments of particular interest, the electrically conductive polymer is soluble in solvents. Several processing approaches are described for forming the blends. The blends are useful in the formation of electrodes, including battery electrodes.

### FIELD OF THE INVENTION

The invention relates to blends of particles and electronically conductive polymers with the polymers serving as particle binders.

### BACKGROUND OF THE INVENTION

Electrically conductive polymers have been studied for some time for use in a variety of devices. Most interest in conductive polymers has been directed at polymers with highly conjugated polymer backbones such as polyacetylene, polyphenylene and the like. To make the polymers electrically conductive, dopants are added that contribute electrons to the conductive bands of the polymer compounds. Relatively high electrical conductivities have been obtained with these compounds.

Polymers with highly conjugated backbones are very rigid polymers. Due to their structure, the polymers generally are difficult to process. In addition, many of the polymers are unstable and/or reactive. These properties have limited the usefulness of conductive polymers.

### SUMMARY OF THE INVENTION

In a first aspect, the invention pertains to a blend comprising an electrically conductive polymer and at least about 10 weight percent solid particles, wherein the electrically conductive polymer binds the particles

In a further aspect, the invention pertains to a method for forming a blend of electrically conductive polymer and solid particle, the method comprising blending an electrically conductive polymer and solid particles. The blending can comprise mixing a solution of electrically conductive polymer with solid particles. In other embodiments, the blending can include mixing a melt of the electrically conductive polymer with solid particles. In further embodiments, the blending can include applying pressure to a mixture of electrically conductive polymer and solid particles.

In another aspect, the invention pertains to an electrode comprising a blend comprising an electrically conductive polymer, solid non-electrically conductive solid particles and less than about 3 weight percent electrically conductive solid particles. In some embodiments, the solid particles intercalate lithium.

### DETAILED DESCRIPTION OF THE INVENTION

Conductive polymer/particle blends are formed with electrically conductive polymers selected to have appropriate mechanical properties such that the polymers are suitable as binders for particles while providing electrical conductivity to the polymer/particle blend. Conductive polymers of particular interest have sufficient single carbon-carbon bonds along the polymer backbone to provide flexibility to the polymer chain to act as a binder. Specifically, the polymer chain has at least significant regions without conjugation along the polymer chain. However, the polymers include conjugated side chains that impart desired levels of electrical conductivity. Blends with high particle loadings can be formed. High particle loadings can be advantageous for certain applications. The flexible polymers/binders can be used in electrode applications in which bound particles provide functional or structural features. Specific uses include battery electrodes, in which electrode active particles are bound by the electrically conductive polymer binder.

Thus, preferred conductive polymer/particle blends have solid particles bound together with electrically conductive polymer binder. The blends generally also include a dopant that contributes to the conductivity to the electrically conductive polymer. In embodiments of particular interest, the electrically conductive polymers have sufficient cohesiveness that the blend holds together as a homogenous composition. For some embodiments, the particle loadings are high. Generally, the blend is flexible following formation into a film or the like. The composition of the particles can be selected for the specific use.

The electrically conductive polymers with appropriate dopant concentration generally have an electrical conductivity of at least about 0.1 Ohm⁻¹cm⁻¹. The polymer backbone preferably has significant single bond character such that the polymer chain is flexible. Flexibility can correlate with cohesiveness that allow the polymer to function as a binder. Suitable electrically conductive polymers have side groups with conjugated structures, such as conjugated carbon rings, conjugated carbon chains and nitrogen-containing conjugated rings.

The particles are selected based on function. Suitable collections of solid particles, i.e., powders, for forming the blends have average diameters of at least about 3 nanometers and no more than about 1 millimeter. In some embodiments, the particles are in the form of fine or ultrafine powders such that the corresponding blend can be formed into relatively smooth films and the like. The particles can include one or more inorganic compounds, such as metal/metalloid oxides, metal/metalloid carbides, metal/metalloid nitride, and metal/metalloid sulfides, although other particle compositions are suitable also. For battery applications, electroactive particles can be used, such as lithium intercalating metal oxides.

The conducting polymer/particle blends described herein provide significant processing versatility with respect to combining features of the inorganic particles within an electrically conductive polymer matrix. Thus, lightweight electrodes can be produced for applications, such as battery applications, solar cells and displays.

A. Blends

The blends include a mixture of electrically conductive polymer and particles with the electrically conductive polymer acting as a binder for the particles. In some embodiments, the particle loading in the blend is high. The blends generally also include a dopant to induce electrical conductivity of the polymer, although the dopant can be incorporated into the polymer itself as a covalently bound functional group. The blends can be formed into desired shapes for the selected application. Generally, structures formed from the blends are somewhat flexible.

In embodiments of particular interest, the blends include at least about 10 weight percent particles held by a conductive polymer binder. In other embodiments, the blends have at least about 25 weight percent, in other embodiments about 35 weight percent particles, alternatively at least about 50 weight percent particle and in other embodiments from about 60 weight percent particles to about 98 weight percent particles, and in still other embodiments from about 70 weight percent to about 95 weight percent. A person of ordinary skill in the art will recognize that intermediate ranges of particle loadings in addition to the particle loadings explicitly described are contemplated and are within the present disclosure.

The conductive polymer/particle blends with an electrically conductive polymer functioning as a particle binder is in contrast with composites with particles adhered to a conductive polymer sphere or in which individual particles are coated with polymer. In these other situations, the polymer does not simultaneously bind multiple particles together to form a cohesive network extending beyond a localized particle. The present blends involve both the binding of multiple particles together to form a cohesive unit with an extended network of polymer forming the cohesive material.

The particles can have a composition selected to be particularly suitable for a particular use. For example, for the formation of lithium based batteries, suitable particles include compositions that intercalate lithium into the compound, such as vanadium oxides, manganese oxides, cobalt oxide, tin oxide and various other metal compounds that intercalate lithium with suitable potentials. Other suitable particles include, for example, graphite particles, carbon black, lithium metal particles and lithium alloy particles.

Suitable polymers include, for example, vinyl polymers with nitrogen-containing conjugated systems extending from the polymer backbone, such as polyvinylpyridine, polyvinylquinoline, polyacrylonitrile, polyvinylcarbazole and derivatives and copolymers thereof A dopant is introduced to provide for the electrical conductivity. In these polymers, the polymer backbone is an alkane chain characteristic of vinyl polymers. Additional conjugation can be introduced in the backbone to further increase electrical conductivity. A small or moderate amount of conjugation in the polymer backbone can increase conductivity without unacceptably modifying the mechanical properties of the polymer/binder. Other suitable polymers include vinyl polymers with other conjugated systems extend as side-groups from the polymer backbone, such as conjugated carbon rings and conjugated linear carbon systems.

Dopants generally can be electron acceptors, such as arsenic pentafluoride, or electron donors, such as alkali metals. For the vinyl polymers with nitrogen containing conjugated side group, an effective dopant is 7,7,8,8-tetracyanoquinodimethane complex salt of N-methylacridinium, as described further in U.S. Pat. No. 3,966,987 to Suzuki et al., entitled “Electroconductive High Polymer Composition,” incorporated herein by reference. Dopants, such as a Bronsted acid group, also can be covalently bonded into the polymer material. For example, see U.S. Pat. No. 5,569,708 to Wudl et al., entitled “Self-Doped Polymers,” and U.S. Pat. No. 6,103,145 to Angelopoulos et al., entitled “Crosslinked Water-Soluble Electrically Conducting Polymers,” both of which are incorporated herein by reference.

Generally, the electrical conductivity of the polymer is a function of the amount of dopants. Thus, the amount of dopant can be selected to yield desired levels of conductivity for particular compositions chosen. Typically, the electrical conductivity initially increases with dopant concentration and reaches a maximum conductivity beyond which the conductivity drops. For many embodiments, the desired level of dopant ranges from about 1 weight percent to about 20 weight percent and in other embodiments from about 3 weight percent to about 12 weight percent.

The electrically conductive polymers generally have electrical conductivity of at least about 0.1 Ohm⁻¹cm⁻¹. In other embodiments, the electrical conductivity is at least about 1 Ohm⁻¹cm⁻¹, and in further embodiment from about 5 Ohm⁻¹cm⁻¹ to about 100 Ohm⁻¹cm⁻¹. A person of ordinary skill in the art will recognize that ranges of electrical conductivity within these explicit ranges are contemplated and are within the present disclosure.

For the formation of electrodes and the like, such as battery electrodes, formed with a polymer binder, the use of an electrically conductive polymer along with selected particles can reduce or eliminate the need to add electrically conductive particles, such as carbon black particles, other carbon particles and metal particles, to impart desired electrical conductivity. Thus, the use of the blends described herein can be especially advantageous for battery electrodes with electrode active particles in a polymer binder. In electrodes formed from the present blends, the electrodes can have less than about 3 weight percent electrically conductive particles, in other embodiments, less than about 1 weight percent and in still other embodiments, less than about 0.5 weight percent electrically conductive particles. A person of ordinary skill in the art will recognize that ranges within these explicit ranges are contemplated and are within the present disclosure. In some embodiments, electrically conductive particles are absent since the electrically conductive polymers contribute sufficient levels of electrical conductivity.

B. Processing to Form the Blends

Preferred form of the conductive polymers are processable using, for example, solvent based techniques or polymer melt processing. For example, polyvinylpyridine, polyvinylquinoline, polyacrylonitrile, and polyvinylcarbazole are soluble in some organic solvents, such as N,N-dimethylformamide. In some embodiments, and the polymer can be dissolved in a selected solvent in which the solid particles are dispersed and cast into a film or other desired form. In some embodiments, the dopant can be dissolved in the same solvent for convenient processing of the blend. The polymer-solid particle solutions-dispersions can be cast, molded or similarly processed, for example using conventional techniques for the processing of polymer solvent solutions.

In contrast, electrically conductive polymers with highly conjugated backbones are generally insoluble in solvents. These polymers can be processed as they are synthesized. To improve processing of these materials, colloidal dispersion approaches have been developed. These are summarized in a chapter by Armes, entitled “Colloidal Dispersions Of Conducting Polymers,” in Handbook of Conducting Polymers, Second Edition, Ed. by Skotheim et al., pp 423-435, (1998), incorporated herein by reference.

Some of the preferred conductive polymers described herein may also be processable as a melt. The polymers can be heated above their melting/flow point without decomposing or otherwise undergoing irreversible modification. The particles and dopants can be combined with the conductive polymer in the melt form. Generally, the components are mixed to form an approximately homogenous blend. The melt blends can be cast, extruded, molded, cast, calendared or otherwise processed into desired forms.

For high particle concentrations, it may be desirable to form the blend through the application of pressure. A mixture is formed of particles of the electrically conductive polymer, the solid particles, and any dopant. The mixture is placed into a die of a desired shape. The mixture is then subjected to high pressures, generally at least about 1000 psig and in some embodiments on the order of 10,000 psig. At the high pressures, the polymer flows around the particles to bind the mixture into a cohesive form. Upon release of the pressure, the blend is formed and can be removed from the die for use.

The composites can be formed into desirable shapes and sizes for the particular applications. For some applications, it may be desirable to form the composites into a layer or coating. Using spin coating or other suitable processes, thin coatings/layers can be formed. For the formation of electrodes, the composite generally is combined with other materials that form a counter electrode that may or may not be also formed of a composite with electrically conductive polymers. The electrodes are generally separated by a dielectric. Suitable separators may include, for example, undoped forms of the conductive polymers incorporated into the blends of the electrode.

The above embodiments are intended to be illustrative and not limiting. Additional embodiments are within the claims below. Although the present invention has been described with reference to specific embodiments, workers skilled in the art will recognize that changes may be made in form and detail without departing from the spirit and scope of the invention.

What is claimed is:

1. A blend comprising an electrically conductive polymer and at least about 10 weight percent solid particles, wherein the electrically conductive polymer binds the particles.

2. The blend of claim 1 comprising at least about 25 weight percent solid particles.

3. The blend of claim 1 comprising at least about 50 weight percent solid particles.

4. The blend of claim 1 wherein the solid particles comprise an inorganic compound.

5. The blend of claim 1 wherein the solid particles comprise metal/metalloid particles, metal/metalloid oxides, metal/metalloid nitrides, metal/metalloid carbides, metal/metalloid sulfides.

6. The blend of claim 1 wherein the polymer is selected from the group consisting of polyvinylpyridine, polyvinylquinoline, polyacrylonitrile, polyvinylcarbazole and derivatives and copolymers thereof.

7. The blend of claim 1 wherein the solid particles intercalate lithium.

8. The blend of claim 1 wherein the solid particles comprise less than about 3 weight percent electrically conductive particles.

9. The blend of claim 1 wherein the solid particles comprise less than about 1 weight percent electrically conductive particles.

10. The blend of claim 1 wherein the electrically conductive polymer has a conductivity at least about 1 Ohm⁻¹cm⁻¹.

11. The blend of claim 1 wherein the electrically conductive polymer comprises an electron accepting dopant or an electron donating dopant.

12. An electrode comprising a blend of claim 1.

13. A battery comprising an electrode of claim 12.

14. A method for forming a blend of electrically conductive polymer and solid particle, the method comprising blending an electrically conductive polymer and solid particles.

15. The method of claim 14 wherein the blending comprises mixing a solution of the electrically conductive polymer with the solid particles.

16. The method of claim 15 further comprising removing the solvent to form a blend of electrically conductive polymer free of solvent.

17. The method of claim 15 wherein the solvent is an organic solvent.

18. The method of claim 14 wherein the blending comprises mixing a melt of the electrically conductive polymer with the solid particles.

19. The method of claim 14 wherein the blending comprises applying pressure to a mixture of particles of electrically conductive particles and solid particles to form the blend.

20. An electrode comprising a blend comprising an electrically conductive polymer, solid non-electrically conductive solid particles and less than about 3 weight percent electrically conductive solid particles, wherein the solid particles intercalate lithium.
